(19) United States
(12) Patent Application Publication
(10) Pub. No.: US 2007/0151453 A1
(43) Pub. Date: Jul. 5, 2007

(54) Cyclone materials treatment system and method of introducing materials to be treated into a cyclone device

(76) Inventor: Manabu Fukuma, Mihara-cho, Sakai-shi (JP)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/324,783

(22) Filed: Jan. 4, 2006

(51) Int. Cl. B01D 45/12

(52) U.S. Cl. 95/271

(57) ABSTRACT

A cyclone system for treating materials in a fluid flow, and a method of introducing fluid containing materials to be treated into a cyclone body of the system are disclosed. The system includes a cyclone having a A method of cyclone body for swirling fluid, a fluid inlet for introducing the fluid, and an outlet duct for evacuating the fluid. At least a part or all of the cyclone body is enclosed within an introduction container and the fluid containing material said fluid inlet to be treated is introduced into the introduction container, then from the introduction container into the cyclone body without continuous piping.

### BACKGROUND OF THE INVENTION

1. Field of the Invention

The present invention relates to a method of introducing a body of fluid containing materials to be treated into a cyclone for treating the materials by providing the fluid containing materials with whirling motion; a cyclone system; to a dust removal device and an incinerator comprising the system; and to an exhaust gas treatment method.

2. Description of the Related Art

In general, in a so-called cyclone (centrifugal dust collector) that provides fluid containing materials to be treated with centrifugal force from a whirling motion for treating the materials, the material is introduced into an almost tubular cyclone body, through a pipeline in a fluid stream containing the materials which stream is directed toward an inner wall of the container body from a tangential direction to generate a whirling speed component. The materials having a greater specific gravity than the fluid drop to the lower part of the container and are pressed against the inner wall of the container body, and the fluid from which the to be treated materials have been removed is discharged from an outlet duct in the upper region near the center of the container body.

This cyclone principle itself was already invented in the 19^{th} century, and at present, many kinds of technologies applying this cyclone principle have been developed in different fields as disclosed, for example in Japanese Patent Application Laid Open No. H6-320055 and Japanese Patent Application Laid Open No.: H110-34022.

### SUMMARY OF THE INVENTION

There is a problem with the conventional method of introducing fluid through a pipeline, however, that the physical loads due to strain or vibration generated during operation of a cyclone are concentrated at the junction between the pipeline and the cyclone body, and the junction is susceptible to failure due to cracking or breaking.

In addition, generally as the pipeline for introducing fluid into a cyclone, it is preferable to use a relatively small diameter pipe in order to improve treatment efficiency or not to disturb whirling currents to be generated in the cyclone body. Thus, the junction area between the pipeline and the cyclone body is smaller, thereby becoming more susceptible to cracks or breakdown.

In addition, there is another problem that in the case in which there is a difference in the shape or size between a so-called transfer tube transferring fluid and materials from various industries, etc. to the pipeline for introduction into the cyclone body, a junction between the transfer tube and the pipeline becomes complicated and requires special welding techniques or connectors of a special shape, which thus increases the cost for joining.

In particular, although in recent days, a so-called multi-cyclone system comprising a plurality of cyclones has been developed (for instance, Japanese Patent Application Laid-Open No. H10-263439), an increased number of cyclones will require pipelines introducing fluid into the respective cyclones, thus increasing junctions between the pipeline and the cyclones, which leads to the problem that the number of parts that may suffer from cracks or damages will increase by the increased number of cyclones.

In addition, space restriction for such multi-cyclone system may present difficulty in installing piping, for introducing fluid to the cyclone system. In a field where installation space is restricted, for example, in a car body as an exhaust gas treatment device of automobiles, etc. installation may become physically impossible.

Hence, as a result of keen examination to solve such problems, the inventor has completed a method of introducing materials into a cyclone system comprising the cyclone body, a fluid inlet for introducing the fluid, and an outlet duct for fluid evacuation, since the method of introducing the fluid and materials into the cyclone body (hereinafter referred to as the inventive method) in which an introduction container not only encloses at least a part or all of said cyclone body, but also exposes the fluid inlet within the said introduction container, and thereby introduces the fluid containing the materials to be treated into the introduction container, the method introduces the fluid into the cyclone body from the introduction container without using continuous piping.

At the same time, the inventor has completed a cyclone system (hereinafter referred to as the inventive system) comprising a cyclone body for swirling fluid, a fluid inlet for introducing the fluid, and an outlet duct for evacuating the fluid; an introduction container enclosing at least a part or all of the cyclone body and exposing the fluid inlet within the container; and an introduction pipe for introducing fluid containing materials to be treated into the introduction container.

More specifically, by not only enclosing part or all of cyclone body, but also exposing the fluid inlet within the introduction container and introducing fluid containing materials to be treated into said introduction container, in other words, by introducing the fluid containing materials to be treated into the cyclone body through the introduction container without directly joining a transfer tube that transfers fluid containing the materials discharged from various industries, etc. to the neighborhood of the cyclone with the fluid inlet in the cyclone body, the inventor has eliminated a junction between the introduction pipe and fluid introduction pipeline, and thus has solved the problem of crack or breakdown occurrence attributable to physical load due to strain or vibration generated during operation of the cyclone and concentrated at the junction between the pipeline and the cyclone body.

In addition, by introducing the fluid containing the materials to be treated into the cyclone body through the introduction container, rather than directly joining the transfer tube with the fluid inlet in the cyclone body, the inventor has developed an introduction system that is extremely inexpensive yet does not require a special welding technique or a connector, etc. which can be constructed even in the case in which the diameter, cross section (inside diameter, size) or a shape of the transfer tube and the fluid inlet differs.

The inventor has also discovered that in a so-called multi-cyclone system that concurrently uses a plurality of cyclones, by not only enclosing at least a part or all of respective cyclone bodies by one introduction container, but also exposing the leading end of each fluid inlet in plurality of cyclones in the said introduction container, the need for complicated piping facilities can be eliminated and a multi-cyclone system of a very simple configuration can be constructed.

In addition, the inventor has discovered that with such a configuration, that is to say, by introducing fluid containing materials to be treated into the cyclone body through the introduction container, rather than introducing it directly into the cyclone body, the materials to be treated in the fluid can be roughly filtered out to some degree in the introduction container, enabling introduction of relatively clean fluid into the cyclone body, thereby improving the treatment efficiency of the fluid as a result.

In particular, the inventor has discovered that the efficiency of rough filtering of the materials to be treated in the fluid in the introduction container can be improved by enclosing the periphery of the cyclone body by the introduction container and further introducing the fluid containing the materials to be treated from the tangential direction of the introduction container.

The present invention has been completed based on the above knowledge, and aims to provide a method of introducing fluid containing materials to be treated into a cyclone body, a cyclone system, and a dust removal device and an incinerator comprising the system, and an exhaust gas treatment method that are simple and have high physical strength, yet are novel and can improve the treatment efficiency.

The present invention provides a method of introducing fluid containing materials to be treated in a cyclone, the cyclone including a cyclone body for whirling fluid, a fluid inlet for introducing the fluid, and an outlet duct for fluid evacuation, wherein the method is characterized in that by not only enclosing at least a part or all of said cyclone body by an introduction container, but also exposing the fluid inlet within the introduction container, it introduces the fluid from the introduction container into the cyclone body without continuous piping.

The present invention is also a cyclone system for treating materials in fluid by providing the fluid containing the materials with a whirling motion, wherein the cyclone system comprises a cyclone including a cyclone body for swirling fluid, a fluid inlet for introducing the fluid and an outlet duct for fluid evacuation, an introduction container enclosing at least a part or all of the cyclone body and exposing the fluid inlet within the said container, and an introduction pipe for introducing the fluid containing the materials to be treated.

In addition, a dust removal device and an incinerator of the present invention are comprised in the inventive system, and an exhaust gas treatment method of the present invention is it treats exhaust gas discharged from an internal combustion engine by using the inventive system. In the following, we describe in detail the inventive system, the dust removal device and the incinerator comprising the inventive system, and the exhaust gas treatment method.

Fluid containing materials to be treated may not be specifically limited so long as it has sufficient fluidity to be able to flow promptly without staying in a cyclone to be used in the inventive method, and its state may be liquid or gas.

Specifically, exhaust gas discharged in various industries such as manufacturing, power generation, construction, waste-disposal, and agriculture, or gas emissions from various transport facilities such as bikes, automobiles, trucks, buses, locomotives and marine vessels, etc. can be treated. In short, the inventive method applies to every type of fluid containing materials to be treated to be generated by some kind of production activities.

In addition, in the inventive method, a cyclone into which fluid containing materials to be treated may not be specifically limited, and a publicly known cyclone comprising a cyclone body for swirling fluid, a fluid inlet for introducing the fluid, and an outlet duct for evacuating the fluid may be used as appropriate.

Then, the inventive method is a method for introducing the fluid containing the materials to be treated into the cyclone body, the method having a major characteristic that by not only enclosing at least a part or all of the cyclone body by an introduction container but also exposing the fluid inlet within the introduction container, it introduces the fluid from the introduction container into the cyclone body without continuous piping.

In other words, in the inventive method, first not only a part or all of the cyclone body is enclosed (sealed) with the introduction container, but also the fluid inlet for introducing the fluid into the cyclone body is exposed within the said introduction container.

Then, in this state, if the fluid containing the materials to be treated was introduced into the introduction container, the introduced fluid would be sequentially fed into the cyclone body, since in the introduction container, there is no other route than fluid inlet for the introduced fluid to escape.

In fact, by introducing fluid containing materials to be treated into the cyclone body through the introduction container, rather than directly connecting the piping for transferring the fluid containing materials to be treated discharged from various industries to the neighborhood of the cyclone with the fluid inlet for introducing the fluid into the cyclone body, the inventive method can eliminate a junction between the piping for transferring the fluid and the fluid inlet, thereby solving the problem of cracks or breakdown resulting from concentration on the junction between the said pipeline and the cyclone body of physical load due to strain or vibration generated during operation of the cyclone.

In addition, since the inventive method introduces the fluid containing materials the to be treated through the introduction container rather than directly joining said transfer tube with the fluid inlet in the cyclone body, even in the case of the diameter cross section or a shape of the transfer tube and the fluid inlet being different, no special welding technique or connector of special shape is required, thus enabling construction of an extremely inexpensive introduction system.

In addition, in a so-called multi-cyclone system that concurrently uses a plurality of cyclones, by not only enclosing at least a part or all of the respective cyclone bodies by one introduction container, but also exposing the fluid inlet in each of the plurality of cyclones in the introduction container, the need for complicated piping facilities can be eliminated and a multi-cyclone system of a very simple configuration can be constructed.

With such a configuration, that is to say, by introducing fluid containing materials to be treated into the cyclone body through the introduction container, rather than introducing it directly into the cyclone body, the materials to be treated in the fluid can settle or be roughly filtered out to some degree in the introduction container, enabling introduction of relatively clean fluid into the cyclone body compared with the case in which the fluid is directly introduced into the cyclone through the piping, thereby improving the treatment efficiency of the fluid as a result.

For rough filtering in the introduction container, it is preferable to protrude the leading end of the fluid inlet in the introduction container, and with such configuration, constant motion energy or directionality, etc., is needed for the treated material in the fluid to enter the cyclone body from the said fluid inlet. This would significantly increase the rough filtering efficiency of the to be treated materials in the fluid in the introduction container.

Furthermore, if the leading end of the fluid inlet protrudes into the introduction container, it is possible to direct the fluid passing through said fluid inlet to be introduced from a tangential direction toward the inner wall of the cyclone body. This allows the fluid passing through the fluid inlet to promptly start the whirling motion in the cyclone body, thereby improving the treatment efficiency in the cyclone.

In particular, it is preferable to enclose the cyclone body with the introduction container by using an almost cylindrical hollow body as said introduction container, and further to introduce the fluid containing materials to be treated from the tangential direction toward the inner wall of the introduction container and let fluid whirl in said introduction container.

By providing whirling motion in the introduction container before introducing the fluid containing materials the to be treated into the cyclone body, a part or all of the materials to be treated in the fluid cannot move to the upper part of the introduction container, i.e., cannot reach the fluid inlet in the cyclone, and thus repeatedly whirls in the lower or middle part of the introduction container. Consequently, relatively clean fluid from which the to be treated materials have been further roughly filtered out can be introduced into the cyclone body.

In addition, the meaning of said “almost cylindrical” includes not only literally a circular cylinder (tubular body) that is a rectangular solid when viewed from the front wherein the inside diameter of the bottom or basal plane and that of the top cover or ceiling plane are identical, but also anything having different inside diameters of the basal and ceiling planes, such as those having a shape like a circular cone that is broken away at a level surface (bell shape or inverted bell shape) or those having the inside diameter that varies in continuity or in incremental steps. In short, in the inventive method, “almost cylindrical” means all hollow bodies in which fluid can whirl, in other words, all hollow bodies whose transverse section is almost circular.

The inventive system is a cyclone system for providing fluid containing materials to be treated with centrifugal force resulting from whirling motion wherein the cyclone system includes a “cyclone” comprising a cyclone body for swirling fluid, a fluid inlet for introducing the fluid into the cyclone body, an outlet duct for evacuating the fluid, an introduction container enclosing at least a part or all of cyclone body and exposing the fluid inlet in the container, and an introduction pipe for introducing the fluid containing the materials to be treated.

A “cyclone” to be used in the inventive system may not be specifically limited, and, any known cyclone that swirls the introduced fluid and employs the principle of treating materials as dust, etc. by using its centrifugal force, i.e., a general cyclone comprising a cyclone body for whirling fluid, a fluid inlet for introducing the fluid, and an outlet duct for evacuating the fluid may be suitably used.

In addition, an introduction container to be used in the inventive system is a container enclosing (sealing) at least a part or all of the cyclone body in the cyclone and exposes said fluid inlet in the container.

Furthermore, an introduction pipe is for introducing the fluid containing materials to be treated into the introduction container, and in general, a transfer tube for transferring fluid containing materials to be treated discharged from various industries, etc. to the vicinity of the cyclone may be used as the introduction pipe.

In the inventive system, the fluid containing materials the to be treated is introduced from introduction pipe into introduction container.

The fluid introduced into the introduction container is sequentially fed into the cyclone body because in the introduction container, there is no other route than said fluid inlet for the introduced fluid to escape.

Then, the fluid containing the materials to be treated fed into the cyclone body is provided whirling motion in the cyclone body, drops the treated materials having greater specific gravity than the fluid to the lower part of the cyclone body while pressing them against the inner wall of the cyclone body, and concurrently lets treated fluid evacuate from the outlet for evacuation that is positioned above and near the center of the cyclone body.

In fact, by introducing into a cyclone body fluid containing materials to be treated through an introduction container rather than directly connecting a transfer tube (introduction pipe) for transferring the fluid and materials discharged from various industries, etc. with a fluid inlet for introducing the fluid into the cyclone body, a junction between the transfer tube (introduction pipe) and the fluid inlet can be eliminated, thereby solving the problem of cracks or breakdown, etc. resulting from concentration on the junction of physical load due to strain or vibration to be generated during operation of the cyclone.

In addition, by introducing fluid containing materials to be treated through an introduction container, rather than directly joining a transfer tube with a fluid inlet in the cyclone body, even in the case diameter, cross section or a shape of the transfer tube and the fluid inlet differs, no special welding technique or a connector of special shape is required, thus enabling construction of extremely inexpensive introduction system.

Therefore, the diameter or cross section of a fluid inlet can be freely selected, and, for instance, the diameter or cross section of the fluid inlet can be configured to be smaller than that of the transfer tube or vice versa. In fact, if the diameter cross section of the fluid inlet is configured to be smaller than that of the transfer tube, the speed of introducing the fluid into the cyclone body can be accelerated, while if the diameter cross section of the fluid inlet is configured to be larger than that of the transfer tube, the speed of introducing the fluid into the cyclone body can be decelerated. Provision of a difference between the diameter cross section of the fluid inlet and that of the inlet may thus enable control of the speed of introducing the fluid into the cyclone body.

In general, however, it is preferable to accelerate the speed of introducing the fluid into the cyclone body to improve the treatment efficiency in the cyclone. Thus, in the present invention, it is preferable to configure the cross section of the fluid inlet to be smaller than that of the transfer tube.

In addition, by introducing the fluid containing materials the to be treated into the cyclone body through the introduction container, the materials in the fluid can be roughly filtered out to some degree in the introduction container, and relatively clean fluid can thus be introduced into the cyclone body compared with the case in which the fluid is directly introduced into the cyclone through continuous piping, thereby improving the treatment efficiency of the fluid as a result.

In particular, when a multi-cyclone system that concurrently uses a plurality of cyclones is constructed, by not only enclosing together at least part or all of respective cyclone bodies in the plurality of cyclones with one introduction container, but also exposing respective fluid inlets in plurality of cyclones in the said introduction container, complicated piping facilities become unnecessary, thereby enabling construction of a multi-cyclone system of a very simple configuration.

Now, when a multi-cyclone system that concurrently uses a plurality of cyclones is constructed, it is preferable to set the total number of the said plurality of cyclones to an even number, and to make the swirling current of half the plurality of cyclones opposite to the direction of the swirling current of the remaining half of the cyclones. With such the configuration, noise phases occurring in the respective cyclones are reversed between the cyclones having the different directions of the swirling currents and mutual noise is cancelled, thus greatly reducing the noise. Thus, this makes it possible to use the inventive system as a silencer or muffling device such as a muffler that reduces engine sound from an internal combustion engine of an automobile, etc.

In the inventive system, it is preferable to protrude the leading end of the fluid inlet in the introduction container, and with such configuration, constant motion energy or directionality, etc., is needed for the treated material in the fluid to enter the cyclone body from the fluid inlet. This significantly increases the rough filtering efficiency of the system.

Furthermore, if the leading end of the fluid inlet for introducing the fluid into the cyclone body protrudes into the introduction container, and connection is made so that the fluid passes through the fluid inlet and is introduced from a tangential direction toward the inner wall of the cyclone body, the direction of introducing the fluid into the cyclone body can be determined while it is passing through the fluid inlet. This allows the fluid passing through the fluid inlet to promptly start a whirling motion in the cyclone body.

The degree of protrusion of the leading end of the fluid inlet may not be specifically limited. However, extremely long protrusion may lead to breakdown or cracks due to physical resistance, etc., such as vibrations during operation of the cyclone or wind pressure to be received from the fluid, etc.

Thus, the length of the protrusion of the leading end of the fluid inlet may generally have a ratio of approximately 0.05 to 1.0 compared with inside diameter of the ceiling plane in the cyclone body, and preferably of approximately 0.1 to 0.5 times this dimension.

If the degree of the protrusion of the leading end of the fluid inlet is set to less than 0.05 times the inside diameter of the ceiling plane in the cyclone body, the efficiency of rough filtering in the introduction container, etc., may decrease, because the degree of the protrusion is to low, while if it is set to 1.0 or greater, breakdown or cracks may occur due to vibrations during operation of the cyclone or physical resistance to be received from fluid, etc., neither which is preferable.

It is preferable to enclose the cyclone body with the introduction container.

In fact, if the cyclone body is enclosed with the introduction container, the junction area of the cyclone body and the introduction container is expanded, which can thus improving durability of the cyclone system of the present invention.

Then, it is preferable to join the ceiling plane of the cyclone body and that of the introduction container by surface contact, or configure the ceiling of the cyclone body and that of the introduction container with a common member, and such the configuration can further improve durability of the inventive system.

In addition, if the introduction container encloses the cyclone body, the fluid containing the introduced materials could be given such a degree of freedom that it can go around the cyclone till it reaches the fluid inlet, which could further increase the efficiency of rough filtering of the materials in the fluid in the introduction container.

Therefore, it is preferable to use an almost cylindrical hollow body as introduction container and to enclose the cyclone body with the introduction container. Use of the almost cylindrical hollow body as the introduction container makes it easier for the fluid containing the introduced materials to pass around the cyclone body.

In particular, it is preferable to actively swirl the materials in the said introduction container by not only using the almost cylindrical hollow body as the introduction container and enclosing the cyclone body with the introduction container, but also using, as the introduction pipe in the said introduction container, a means of introducing the fluid from the tangential direction toward the inner wall of the said introduction container.

In other words, by swirling the fluid containing the to be treated materials in the introduction container before introducing it into the cyclone body, a part or all of the to be treated materials in the fluid cannot move to the upper part of the introduction container, i.e., cannot reach the fluid inlet in the cyclone, and thus repeatedly whirls in the lower or middle part of the introduction container. Consequently relatively clean fluid from which the to be treated materials have been further roughly filtered out can be introduced into the cyclone body.

In addition, the term “almost cylindrical” is intended to include not only tubular cylinder that is a rectangular solid when viewed from the front wherein the inside diameter of the ceiling and that of the base are identical, but also anything having different inside diameters of the ceiling and base, such as those having a shape of a circular cone that is broken away at a level surface (bell shape or inverted bell shape) or those having an inside diameter that varies in continuity or in incremental steps. In short, in the inventive system, “almost cylindrical” is intended to mean all hollow bodies in which fluid can be caused to whirl, in other words, all hollow bodies whose transverse section is almost circular.

Now, if the fluid containing materials is swirled in the introduction container, it is preferable to arrange the fluid inlet in the cyclone in a position opposed to the swirling current occurring in introduction container. This is because of the following:

When fluid is introduced from a fluid inlet in a general cyclone, the to be treated materials of uniform distribution density, irrespective of their positions on the section, will flow in, because materials in the fluid that passes through the fluid inlet are distributed almost uniformly in the cross section of the fluid inlet.

Thus, the materials entering the cyclone body from a position closer to the cyclone body at the fluid inlet will have a smaller gyration radius than that of particles entering from a position farther from the cyclone body at the fluid inlet, thus not only being unable to gain the necessary centrifugal force, but also contacting the swirling current of the cyclone body and disturbing the swirling current, which leads to the problem of reduced treatment efficiency.

In this respect, if a whirling motion is given to the materials in the introduction container, the materials in the fluid are pressed against the inner wall of the introduction container, i.e., distribution of the to be treated materials in the fluid is biased to the inner wall direction of the introduction container. Then, if the fluid in such distribution state is directly introduced into the cyclone body, can overcome the defect of the conventional cyclone system, namely, reduction of the treatment efficiency attributable to the distribution state of the materials in the fluid.

Thus, in the inventive system, it is preferable to locate the fluid inlet in the cyclone opposed to the swirling current in the introduction container, and such configuration could enable direct introduction into the cyclone body of the fluid with the materials therein distributed biasedly toward the inner wall of the introduction container, thereby improving the treatment efficiency attributed to how the materials in the fluid are introduced.

In addition, with such configuration, since the materials in the fluid introduced into the cyclone body are well distributed to be treated in extremely short time, the length of the cyclone body and the introduction container can be shortened. Thus, the inventive system can be applied even in the field in which installation space for a long cyclone system is not available and, for instance, can be installed in a car body, as an emission treatment device, etc., for automobiles.

Now, as the to be treated materials are pressed against the inner wall of the introduction container when the fluid containing to be treated materials is swirled in the introduction container, the distribution density of the materials is highest in or near the inner wall surface of the introduction container, and this distribution density gradually decreases toward the center of the introduction container.

Thus, in this state, if the leading end of the fluid inlet in the cyclone body is arranged by the inner wall of the introduction container, fluid with relatively high content of to be treated materials will be introduced into the cyclone body.

On the one hand, in this state, if the fluid inlet in the cyclone body is arranged closer to the center than to the inner surface of the introduction container, relatively clean fluid will be introduced into the cyclone body.

In fact, when the fluid having the less materials content is treated or when a cyclone with higher treatment capacity is used, more materials can be treated in the cyclone if the fluid inlet in the cyclone body is arranged by the inner surface of the introducing wall and more materials are introduced into the cyclone. On the contrary, when the fluid having more materials content is treated or when a cyclone with lower treatment capacity is used, more materials can be treated in the introduction container by positioning the fluid inlet in the cyclone body closer to the center side than to the inner wall of the introduction container.

In addition, in the inventive system, it is preferable to change a position of the fluid inlet in the introduction container arbitrarily or according to quantity of the materials in the fluid, as appropriate.

For instance, usually, emission gas emitted from an internal combustion engine, such as a car engine has a higher content treated materials such as particulate pollutants (hereafter P.M.), when the inventive system runs at low speed, while it has a lower content of materials such as PM when the inventive system runs at high speed.

Hence, it is preferable to change, as appropriate, the position of the fluid inlet in the introduction container arbitrarily or according to quantity of materials in the fluid, and with such the configuration, it also becomes possible to handle those in which the content of the materials varies depending on such operating states.

Then, if fluid containing materials to be treated is whirled in the introduction container, the introduction container gets smaller from a position where the introduction pipe is provided in the introduction container to a position where the fluid inlet is provided in the cyclone body. In other words, it is preferable to make the inside diameter of the ceiling plane in the almost cylindrical introduction container smaller than that of the basal plane in the introduction container. With such the configuration, the swirling speed of the fluid introduced from the introduction pipe into the introduction container can be accelerated to the level that the speed reaches the fluid inlet in the cyclone, thus not only being able to apply stronger centrifugal force to the materials in the fluid, but also accelerating the speed of introducing the fluid into the cyclone body.

In this case, although it is also acceptable to continuously (gradually) reduce the inside diameter of the introduction container from the basal plane to the ceiling plane, it is preferable to reduce the inside diameter of the introduction container in phases from the basal plane to the ceiling plane. With such configuration, each stage in the introduction container becomes a barrier and makes it difficult for the materials in the fluid to go beyond the each stage in the introduction container, thus further improving the efficiency of rough filtering in the introduction container.

As described above, the inventive system is comprised by enclosing a part of all of the cyclone body with the introduction container. In addition, it is also acceptable to sequentially enclose a part or all of the introduction container with one or more separate introduction containers, and thus materials in the fluid can be roughly filter out in the respective introduction containers by providing more than one introduction container, thereby being able to improve the treatment efficiency of the whole cyclone system of the present invention.

In addition, one or more introduction containers that enclose the introduction container may be same as the introduction container that encloses the cyclone body as described above. Although we omit the description herein to avoid repetitions, naturally, the inlets for each fluid introduction are provided in different introduction containers, and these inlets are arranged not to be exposed in a second introduction container that encloses a first introduction container.

In the inventive system, materials roughly filtered out in the introduction container are collected in the introduction container, while materials treated in the cyclone are respectively collected in the cyclone.

Then, the collected materials should be removed in due course or regularly.

If the materials are safe to human bodies, there is no problem except that the removal procedure is complicated. However, in the case of PM or graphite or other fine particles, it is possible that workers who breathes them may suffer from health hazard such as pneumoconiosis, etc., and it is also reported that in particular, PM or graphite may contain carcinogens.

Thus, it is preferable to provide in the introduction container and/or cyclone body a catalyst and/or absorbent for detoxifying or absorbing materials, and it is preferable to have the materials contact the catalyst in the introduction container or the cyclone body for treatment.

As a part or all of the materials is repeatedly subject to swirling motion in the introduction container or the cyclone body, it has been confirmed that these materials are rubbed on the inner wall during the swirling motion, become so-called burn-out, and are finally gasified into a gas such as carbon dioxide, etc.

Therefore, when most of materials in fluid are fine particles, such as emissions from internal combustion engines most fine particles in the emission gas can be gasified by repeatedly subjecting the fluid containing such materials to swirling motion in the inventive system. Thus, intervals needed for removing collected materials can be significantly extended, thereby realizing so-called free maintenance.

In addition to subjecting fluid containing materials in the introduction container to swirling motion in the inventive system, if a catalyst and/or absorbent that absorbs or detoxifies the materials are/is provided in the introduction container and/or cyclone body, the intervals needed for removal of collected to be treated materials can be significantly extended, thereby realizing so-called maintenance-free.

In addition, the materials in the fluid repeatedly make contact with the catalyst or absorbent while whirling and have many contacts with the catalyst or absorbent, which can further improve the efficiency of detoxification or absorption by the catalyst or absorbent.

In addition, although a catalyst to be used may not be specifically limited, as far as by making contact with the particulate or gasified materials, it treats the particulate materials or gasified materials into almost same manner, to be more precise, a publicly known inorganic catalyst or urea crystal such as platinum or alumina catalyst, etc., for instance, may be suitably used.

On the one hand, an absorbent to be used in the inventive system may not be specifically limited as far as by making contact with the particulate materials in the fluid or gasified materials, it absorbs the particulate or gasified materials, and a publicly known absorbent such as activated charcoal or silica gel, zeolite or powder or granulation of porous ceramics may be used.

A device of the present invention may be employed as a novel dust removal device. In fact, such a device introduces into a cyclone body and treats, without continuous piping, fluid containing dust discharged from various industries, and that it is an exceptional dust removal device in that it has excellent durability, high treatment efficiency and yet can significantly extend intervals needed for removal of collected to be treated materials or realize so-called free maintenance.

The device of present invention also serves as novel incinerator. In fact, it introduces into a cyclone body and treats, without continuous piping, smoke containing incineration ash that includes toxic substances such as dioxin, etc., discharged from incinerators, and is an exceptional incinerator in that it has excellent durability, high treatment efficiency, and, in particular, can gasify such toxic substances as dioxin, etc. into a gas such as carbon dioxide, etc., by repeatedly providing swirling motion in an introduction container, and yet can significantly extend intervals needed for removal of collected to be treated materials or realize so-called free maintenance.

An effective exhaust gas treatment method is provided for emission gas from internal combustion engines by using said inventive system. In fact, it introduces into a cyclone body and treats, without continuous piping, emission gas to be emitted from internal combustion engines as typified by engines of automobiles or marine vessels, etc., and is an exceptional exhaust gas treatment method in that it has excellent durability, high treatment efficiency, and yet can significantly extend intervals needed for removal of collected to be treated materials, or realize so-called free maintenance, and can eliminate the need for installation of such a muffing device as a muffler by noise reduction through the use of a plurality of cyclones.

The present invention provides a method of introducing fluid containing new to be treated materials into a cyclone body; a cyclone system, a dust removal device and an incinerator comprising the system, and an exhaust gas treatment method that have the configurations described above, are simple, have high physical strength, and yet can improve treatment efficiency.

The invention also provides a method of introducing fluid containing materials into a cyclone body in a cyclone including a cyclone body, a fluid inlet for introducing the fluid into the body, and an outlet evacuating the fluid. By enclosing at least a part or all of said cyclone body with an introduction container, and exposing the fluid inlet in the introduction container, and introducing the fluid containing the materials to be treated into said introduction container, the fluid and materials are introduced into the cyclone body without continuous piping.

The system comprises a cyclone body for swirling fluid, a fluid inlet for introducing the fluid into and an outlet duct for evacuating the fluid from the body, and a container for enclosing at least a part or all of said cyclone body. An introduction container for exposing the fluid inlet in the container and an introduction pipe for introducing fluid containing to be treated materials into the introduction container are provided.

By enclosing at least a part or all of a cyclone body with an introduction container exposing the fluid inlet in the introduction container, and introducing fluid containing materials to be treated into the introduction container for introduction into the cyclone body rather than directly joining a transfer tube for transferring the fluid and materials to the vicinity of the cyclone, the conventional junction between the introduction pipe and the fluid introduction pipe can be eliminated, and thus solve the problem of cracks or breakdown attributable to stress concentration on the junction between the said pipeline and the cyclone body of physical load due to strain or vibrations during operation of the cyclone.

By introducing fluids containing materials to be treated into the cyclone body through the introduction container rather than directly connecting the transfer tube and the fluid inlet in the cyclone body, the present invention can construct an extremely inexpensive introduction system without the need of a special welding technique or a connector, etc., even in the case in which the cross section, size or a shape of the transfer tube and the fluid inlet differs.

Furthermore, in a so-called multi-cyclone system of the type that concurrently uses a plurality of cyclones, by enclosing at least a part or all of the respective cyclone bodies by one introduction container exposing the leading end of each fluid inlet in the plurality of cyclones in the introduction container, the need for complicated piping facilities can be eliminated and a multi-cyclone system of a very simple configuration can be constructed.

By introducing fluid containing materials to be treated into a cyclone body through an introduction container, rather than introducing it directly into the cyclone body, the to be treated materials in the fluid can be roughly filtered out to some degree in the introduction container, and relatively clean fluid can be introduced into the cyclone body, thereby improving the treatment efficiency of the fluid as a result.

By making the introduction container substantially cylindrical, enclosing the cyclone body with the introduction container, introducing fluid containing materials to be treated from a tangential direction of the introduction container, and subjecting the fluid to a swirling motion in the introduction container, the rough filtering efficiency in the introduction container can be improved.

The present invention may be embodied as a dust removal device that has excellent durability, high treatment efficiency, and yet can significantly extend intervals needed for removal of collected to be treated materials, or realize so-called free maintenance.

The present invention can be embodied as an exceptional incinerator in that it has excellent durability, high treatment efficiency, and by repeatedly providing swirling motion in an introduction container, in particular, can gasify such toxic substances as dioxin, etc., into gas such as carbon dioxide, and yet can significantly extend intervals needed for removal of collected to be treated materials or realize so-called free maintenance.

The system may be employed in an exhaust gas treatment method for exhaust gas discharged from internal combustion engines and is an exceptional exhaust gas treatment method in that it has excellent durability, high treatment efficiency, and yet can significantly extend intervals needed for removal of collected to be treated materials or realize so-called free maintenance, or can eliminate the need for installation of such a muffing device as a muffler by noise reduction through the use of a plurality of cyclones.

### BRIEF DESCRIPTION OF THE DRAWINGS

Other features and advantages of the invention will become apparent from the detailed description contained herein below, taken in conjunction with the drawings, in which:

FIG. 1 is a schematic view showing a cyclone system according to a first embodiment of the present invention;

FIG. 2 is a top schematic view showing how materials to be treated in fluid moves in the cyclone system of FIG. 1;

FIG. 3 is a schematic view showing the cyclone system of a second embodiment of the present invention;

FIG. 4 is a schematic view showing a third embodiment of the cyclone system of the present invention;

FIG. 5 is a schematic view showing distribution of materials to be treated in fluid in an introduction container of the cyclone system of the present invention shown in FIG. 4;

FIGS. 6A and 6B are schematic views showing a difference in introduction state of fluid depending on changes in positions of fluid inlet in the cyclone system of the embodiment shown in FIG. 4;

FIGS. 7A and 7B are schematic views showing a different example of the fluid inlet in the cyclone system of the embodiment of FIG. 3;

FIG. 8 is a schematic view showing a fourth embodiment of the cyclone system of the present invention;

FIG. 9 is a schematic view showing a fifth embodiment of the cyclone system of the present invention;

FIG. 10 is a schematic view showing a sixth embodiment of the cyclone system of the present invention; and

FIG. 11 is a schematic view showing a seventh embodiment of the cyclone system of the present invention.

### DESCRIPTION OF THE PREFERRED EMBODIMENTS

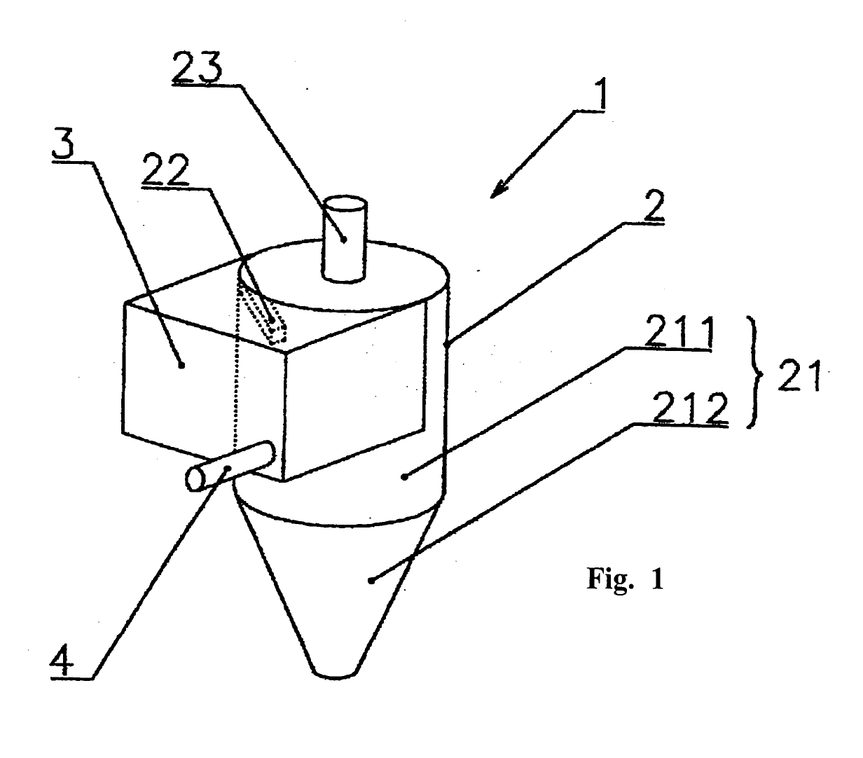

FIG. 1 is a schematic view showing the inventive system 1 according a first embodiment wherein by showing an introduction container 3 in a see-through state, the inside of the said introduction container 3 is made visible.

Then, the inventive system 1 according to the embodiment comprises a cyclone 2, an introduction container 3, and an introduction pipe 4.

The cyclone 2 may be a conventional cyclone that utilizes the principle of swirling introduced fluid and materials to be treated such as dust, etc. by using centrifugal force thereof, and is a general cyclone that comprises a cyclone body 21 comprising a generally cylindrical body 211 for swirling fluid and a generally conical lower body 212. A fluid inlet 22 for introducing the fluid, and an outlet duct 23 for evacuating the fluid are shown.

In addition, the introduction container 3 is a container enclosing at least a part or preferably all of the cyclone body and exposes the fluid inlet 22 in the container.

The introduction pipe 4 is provided for introducing fluid containing materials to be treated into the introduction container 3, and in general, pipe 4 is a transfer tube for transferring materials discharged from various industries to the vicinity of the cyclone is used as the introduction pipe.

In the embodiment, fluid containing materials to be treated is introduced from the introduction pipe 4 into said introduction container 3.

As the fluid introduced into the introduction container 3 has no other route to escape than fluid inlet 22 in the said introduction container 3, the introduced fluid flows from container 3 into the cyclone body 21.

Then, the fluid containing materials that was fed into the cyclone body 21 is provided with swirling motion in the cyclone body 21, drops the to be treated materials having a greater gravity than the fluid into the lower part of the cyclone 21, while pressing them against the inner wall of the cyclone body 21, and the treated fluid is discharged from the outlet duct 23 for evacuation that is raised near the center of the cyclone body 21.

In the first embodiment, by introducing the fluid material into the cyclone body 2 through the introduction container 3, rather than directly connecting the introduction pipe 4 and the fluid inlet 22, a junction between the introduction pipe and the fluid inlet is eliminated, and thus the problem of cracks or breakdown resulting from concentration on the junction of physical loads due to strain or vibrations during operation of the cyclone 2 is avoided.

In this embodiment, by introducing the fluid and materials into the cyclone body 21 through the introduction container, rather than directly joining the introduction pipe 4 and the fluid inlet 22, a special welding technique or a connector, etc. is not required, thereby enabling construction of an extremely inexpensive introduction system even in the case in which the diameter, cross section, size or a shape of the introduction pipe 4 and the fluid inlet 22 differs.

Furthermore, provision of a difference between the cross section of the introduction pipe 4 and that of the fluid inlet 22 may be employed to control the speed of introducing the fluid into the cyclone body 21. In particular, by making the cross section of the introduction pipe 4 smaller than that of the fluid inlet 22, the speed of introducing the fluid into the cyclone body 21 can be accelerated, thereby considerably improving the treatment efficiency as a result.

With this configuration, i.e., by introducing materials into the cyclone body through the introduction container 3 rather than directly introducing it into the cyclone body 21, the materials in the fluid are roughly separated or filtered out to some degree in the introduction container 3, and relatively clean fluid is introduced into the cyclone body 21 compared with the case in which the fluid is introduced directly into the cyclone through the piping, resulting in the improved treatment efficiency of the fluid.

In this first embodiment, the upstream or leading end of the fluid inlet 22 is protruded in the introduction container 3, and the downstream end is connected to the cyclone body so that the fluid is introduced in a tangential direction along the inner wall of the cyclone body 21.

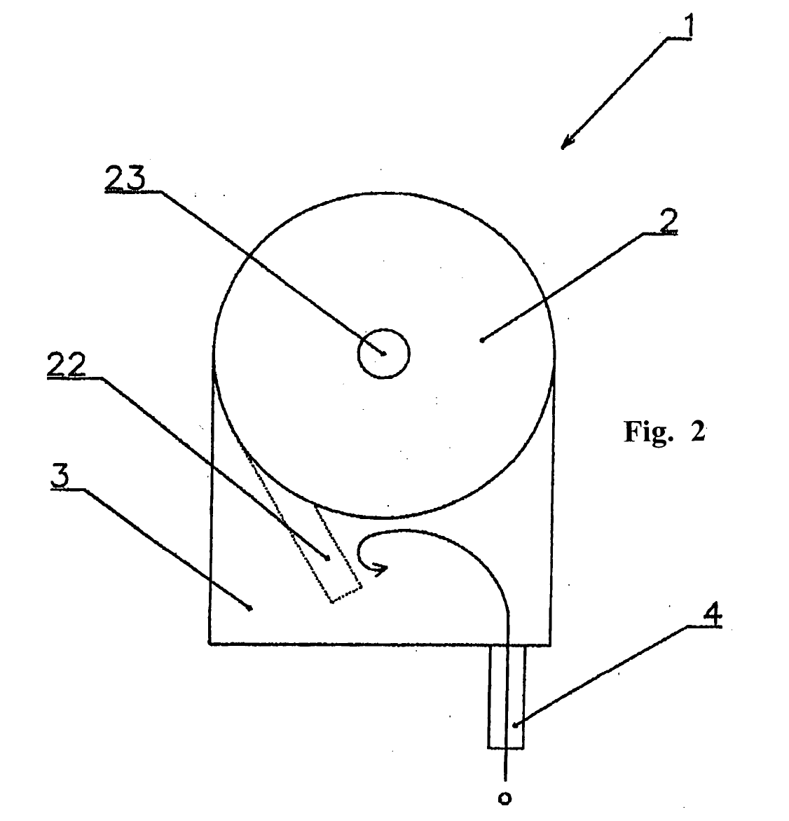

This is because, as shown in FIG. 2, if the leading end of the fluid inlet 22 protrudes into the introduction container 3, constant motion energy and directionality are required for the materials in the fluid introduced into the introduction container 3 from the inlet 4 to reach and enter the cyclone body 21 from the fluid inlet 22, which thus considerably enhances the rough filtering effect of the to be treated materials in the fluid in the introduction container 3.

With the fluid inlet 22 connected so that the fluid is introduced is the tangential direction along the inner wall of the cyclone body 21, a direction of introducing the fluid into the cyclone 21 can be determined, while passing through fluid inlet 22, which allows the fluid passing through the fluid inlet 22 to promptly start whirling motion in the cyclone body 21.

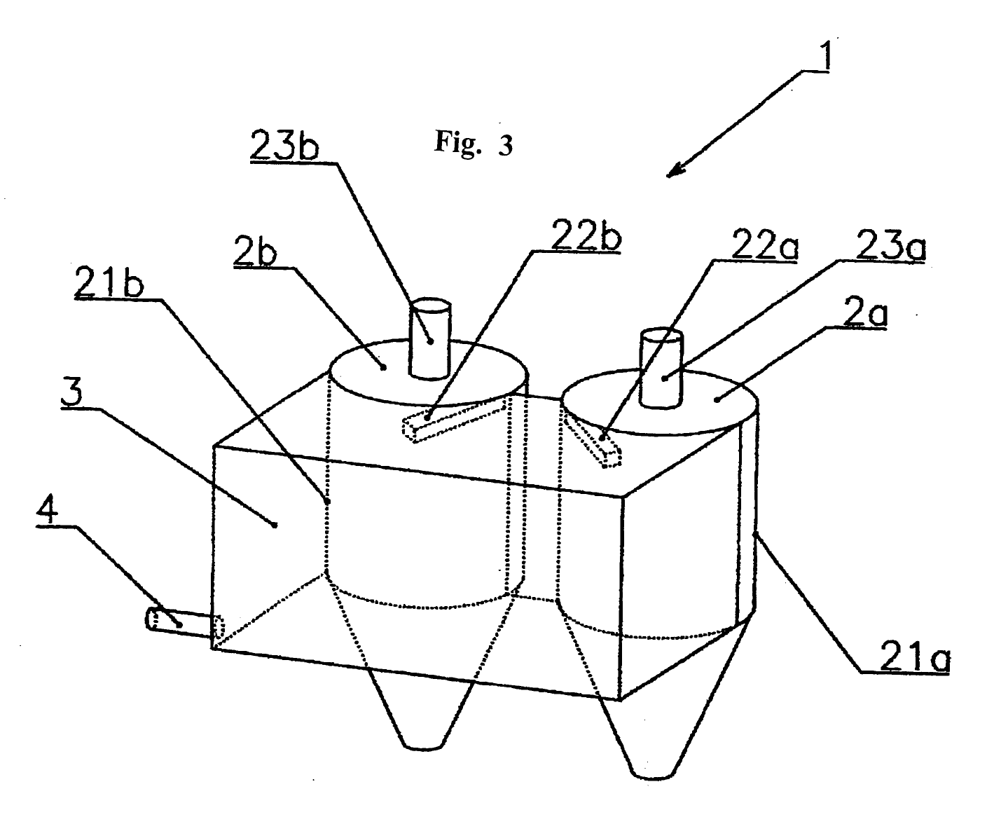

FIG. 3 is a schematic view of a second embodiment of the inventive system 1 wherein by showing an introduction container 3 in see-through state inside of the said introduction container 3 is made visible.

Then, the inventive system 1 according to this embodiment comprises a first cyclone 2a, a second cyclone 2b, a common introduction container 3, and a common introduction pipe 4.

The inventive system 1 according to this embodiment is a so-called multi-cyclone system that conventionally uses the plurality of cyclones 2a, 2b, with only one introduction container 3 enclosing at least a part or all of the respective cyclone bodies 21a, 21b and respective fluid inlets 22a, 22b in said plurality of cyclones 2a, 2b which protrude into the introduction container 3 this FIG. 3 shows a multi-cyclone system of a very simple configuration in which the need for complicated piping facilities is eliminated.

In this embodiment, the configuration is such that a direction of swirling current of one cyclone 2a is opposite to a direction of swirling current of cyclone 2b, and with such configuration, noise phases occurring in the respective cyclones are reversed and mutual noise is cancelled, thus making for very quiet operation.

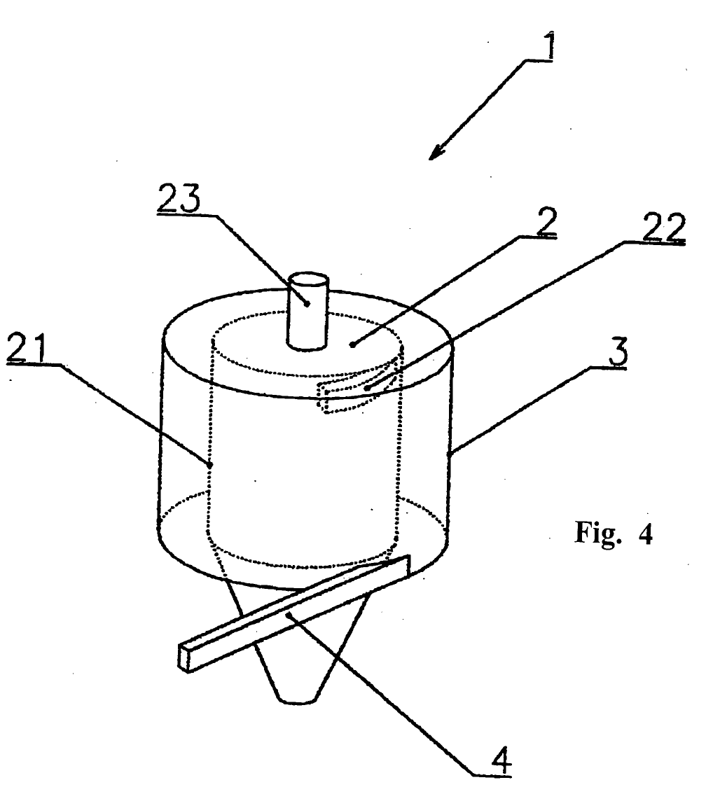

FIG. 4 is a schematic view showing the inventive system 1 of a third embodiment wherein by showing the introduction container 3 in see-through state, the inside of the introduction container 3 is made visible.

Then, the inventive system 1 according to this embodiment comprises a single cyclone 2, an introduction container 3 and an introduction pipe 4, wherein the cylindrical introduction container 3 encloses the cyclone body 21.

According to this embodiment the cyclone body 2 enclosed by an almost cylindrical introduction container 3, wherein a junction area between the cyclone body 21 and the introduction container 3 expands, thereby further improving durability.

In addition, the ceiling plane of the cyclone body 21 and the base plane of the introduction container 3 are formed of common members, i.e., a part of the ceiling plane of the cyclone body 21 and that of the introduction container 3 is commonly used, thus improving durability even further.

Then, in this embodiment, an almost cylindrical hollow body is used as the introduction container 3, and the introduction pipe 4 into the introduction container 3 introduces fluid and material in the tangential direction along the inner wall of the introduction container 3, which provides the fluid with a swirling motion in the introduction container 3 before it is introduced into the cyclone body 21. With such configuration, a part or all of the materials in fluid does not move to the upper part in the introduction container 3, i.e., it will not reach the fluid inlet 22 in the cyclone 2 and repeatedly whirls in the lower or middle part of the introduction container 3. This consequently enables introduction into the cyclone body 21 of relatively clean fluid from which further to be treated materials have been roughly filtered out. The fluid inlet 22 in the cyclone 2 is contained in the introduction container 3 and its inlet is opposed to the outlet of introduction pipe 4.

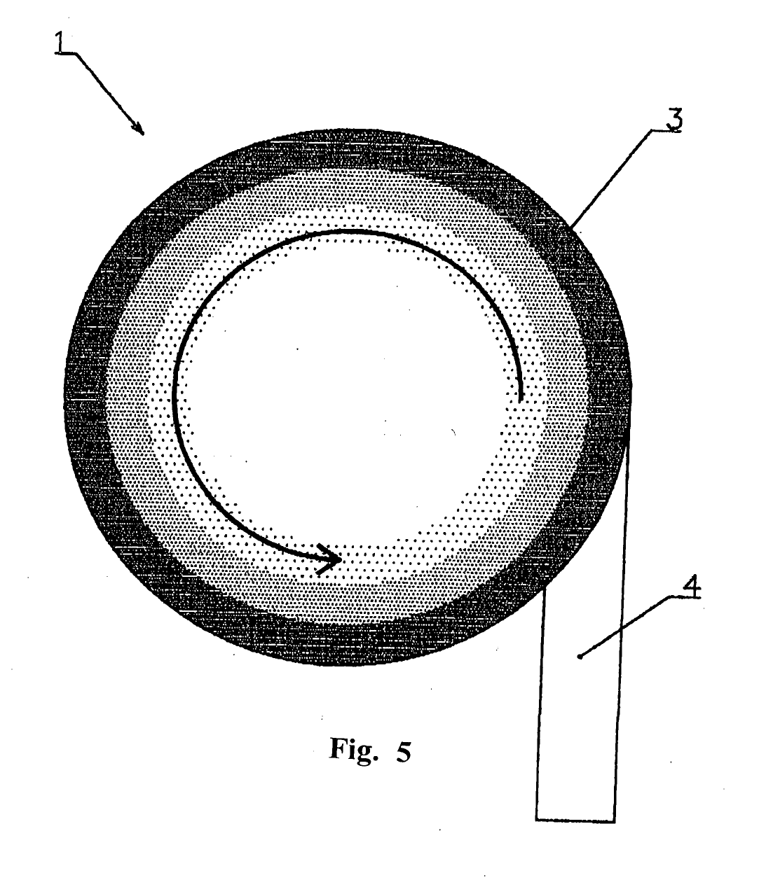

As shown in FIG. 5, in this embodiment, since fluid containing materials to be treated is given swirling motion in the introduction container 3, the materials in the fluid are pressed against the inner wall of the introduction container, i.e., distribution of the materials in the fluid is biased to the direction to the inner surface of the introduction container.

Then, as the fluid inlet in the cyclone is opposed to the swirling direction of the fluid in the introduction container, the fluid can be introduced into the cyclone body 21 with the distribution of the to be treated materials in the fluid biased to the inner wall direction of the introduction container 3 unchanged, thus enhancing the treatment efficiency attributable to the introduction state of the materials in the fluid.

With such configuration, since the materials in the fluid introduced into the cyclone body 21 are well distributed to be treated in an extremely short time, the length of the cyclone body 21 and of the introduction container 3 can be reduced. Thus, the inventive system can be applied even where installation space for a long cyclone system is not available and, for instance, can be installed in a car body as an emission treatment device for automobiles.

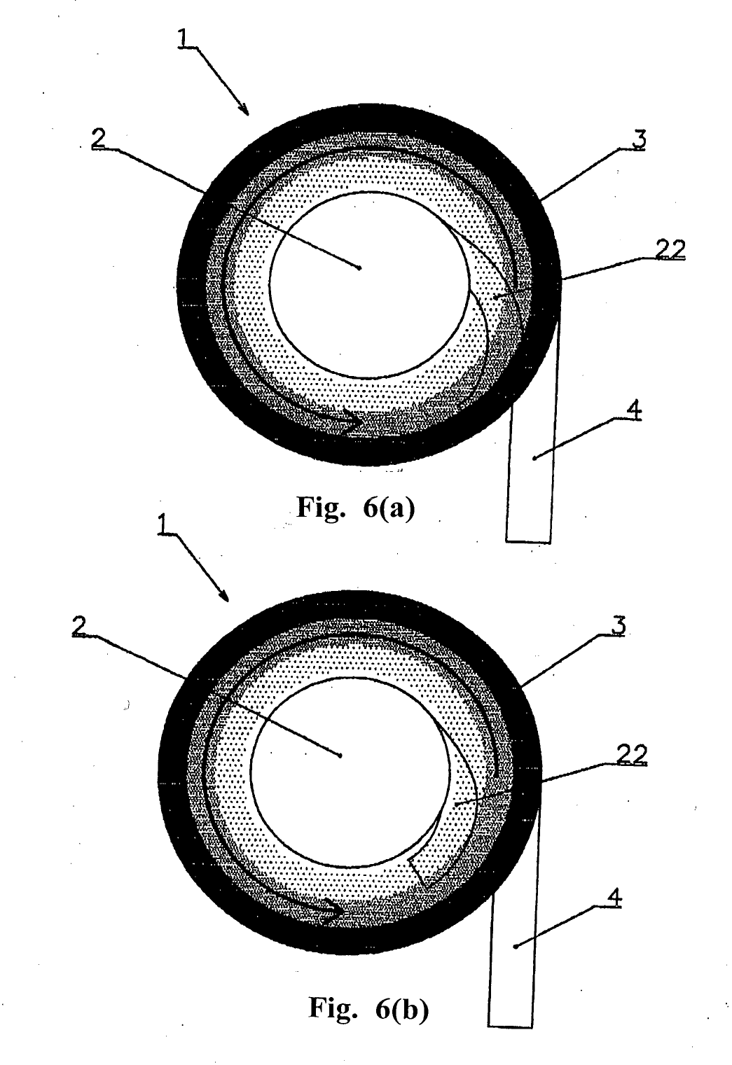

As shown in FIG. 6A, if the inlet or leading end of the fluid inlet 22 in the cyclone body 21 is arranged near the inner surface of the introduction container 3, fluid with relatively high materials content will be introduced into the cyclone body 21. On the one hand, as shown in FIG. 6B, if the fluid inlet 22 in the cyclone body 21 is arranged closer to the center of the space between the cyclone body and the inner wall of the introduction container 3, relatively clean fluid will be introduced into the cyclone body. Thus, when fluid having less materials content is treated or when a cyclone 2 with higher treatment capacity is used, more materials may be treated in the cyclone 2 by positioning the fluid inlet 22 nearer to the inner wall of the introduction container 3 thereby introducing more materials into the cyclone body 21. Contrarily, when fluid having greater materials content is treated or when a cyclone 2 with lower treatment capacity is used, more materials may be treated by positioning the fluid inlet 22 in the cyclone body 21 at a greater distance from the inner wall surface of the introduction container 3.

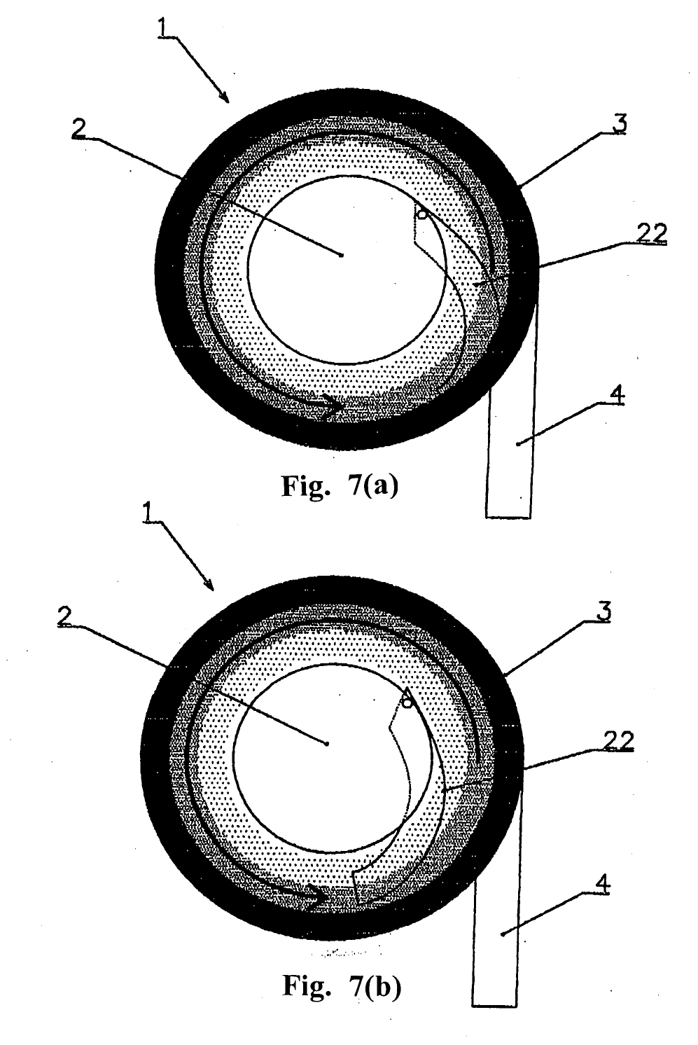

In addition, as shown in FIG. 7, the fluid inlet 22 may be movably mounted such that its inlet end position may be adjusted with the space between the cyclone 21 and the inner wall surface of the introduction container 3 as appropriate, depending on the amount of materials in the fluid. With such configuration, it becomes possible to handle, as needed, even the case in which the content materials in the fluid varies.

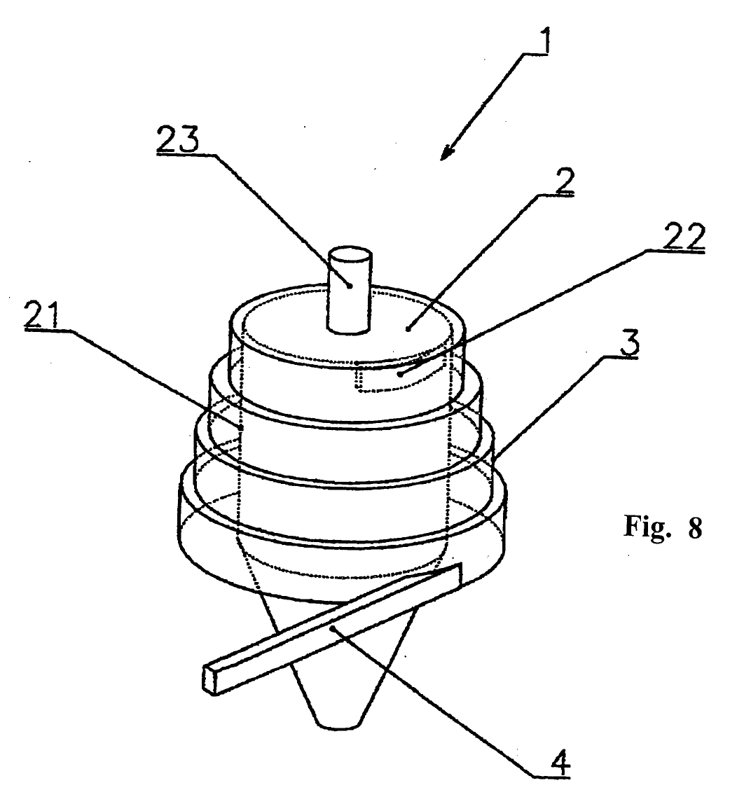

FIG. 8 is a schematic view showing the inventive system 1 according to the fourth embodiment wherein by showing an introduction container 3 in see-through state, the inside of the said introduction container 3 is made visible. This embodiment comprises a cyclone 2, an introduction container 3 and an introduction pipe 4, wherein the cylindrical introduction container 3 encloses a cyclone body 21. This substantially cylindrical introduction container 3 is configured such that its inside diameter decreases in steps from the base to the top plane. With such configuration, the swirling speed of the fluid introduced into the introduction container 3 from the introduction pipe 4 can be accelerated until the fluid reaches the fluid inlet 22 in the cyclone, which can not only provide materials in the fluid with adequate centrifugal force but also accelerate the introduction speed of the fluid into the cyclone body 21.

Since the configuration is such that the inside diameter of the introduction container 3 decreases in phases from the base to the top, each stage in the introduction container 3 becomes a barrier, making it difficult for the materials in the fluid to rise beyond the each stage in the introduction container 3, which thus further improves the efficiency of rough filtering in the introduction container 3.

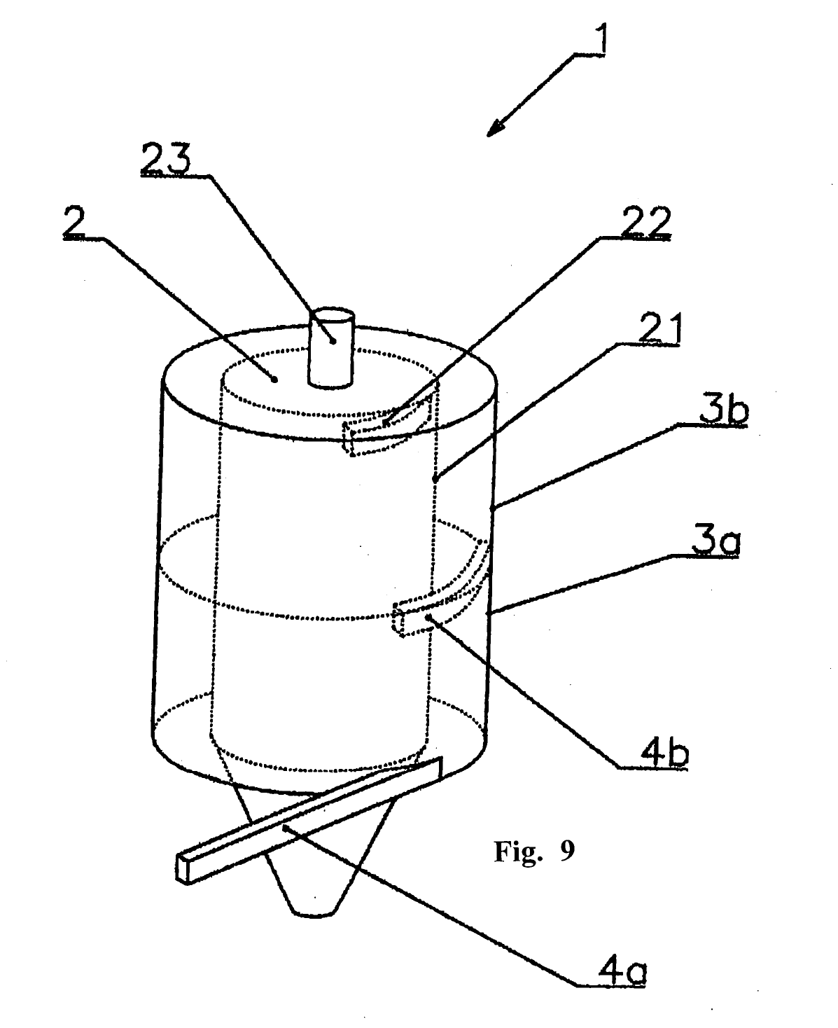

FIG. 9 is a schematic view showing the inventive system 1 according a fifth embodiment wherein by showing a compartmental introduction container 3 having two compartments 3a, 3b is illustrated in see-through state, the inside of the introduction container 3 (3a, 3b) is made visible. This embodiment comprises a cyclone 2, an almost cylindrical introduction container 3 (3a, 3b), a first introduction pipe and a second introduction pipe 4b leading from introduction container 2 or to introduction container 3b, wherein materials in fluid are roughly filtered in the respective introduction containers 3a, 3b, and the treatment efficiency as a whole cyclone system can be improved.

The introduction of fluid from the introduction container 3a to the introduction container 3b takes place through the introduction pipe 4b which is such configured such that liquid that is given swirling motion in the introduction container 3a is not only run off from the tangential direction but also is flowed to the inner wall of the introduction container 3b from the tangential direction.

Thus, in this embodiment, the fluid can be introduced into the introduction container 3b with the distribution of the materials in the fluid biased to the inner wall direction of the introduction container 3a unchanged, and furthermore, the fluid can be introduced, into the cyclone body 21 with the distribution of the materials in the fluid further biased to the inner wall direction of the introduction container 3b.

In addition, provision of a difference the cross section of in the introduction pipe 4a, introduction pipe 4b, and the fluid inlet 22, respectively could enable control of the introduction speed of the fluid.

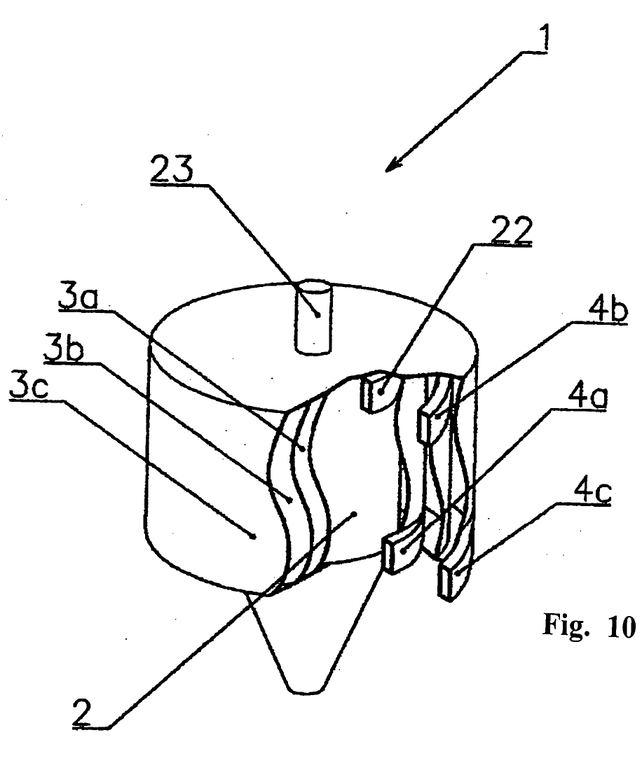

FIG. 10 is a schematic view showing the inventive system 1 according to a fifth embodiment wherein by showing concentric introduction containers 3a, 3b, 3c with a part thereof broken away, the inside of the said introduction containers 3a, 3b, 3c is made visible.

The embodiment comprises a cyclone 2, a first almost cylindrical introduction container 3a having an introduction pipe 4a, and two further introduction container 3b, 3c having introduction pipes 4b, 4c, respectively sequentially enclosing introduction container 3a.

In this embodiment the introduction containers are concentrically provided in layers, wherein as materials in fluid are roughly filtered out in respective introduction containers 3a, 3b, 3c, and the treatment efficiency as a whole cyclone system can be improved.

The construction of introduction containers 3a, 3b, and 3c can be substantially the same except that the inside diameters are different. Also in the separate introduction containers 3b, 3c are provided inlets 4b, 4c for introducing fluid, respectively, wherein the inlet 4a in the introduction container 3a is such arranged that it is exposed or protruded within and near the base of the separate introduction container 3b that surrounds outer side of the innermost layer, and the fluid inlet 4b in the separate introduction container 3b is arranged near the top of and is exposed or protruded within the separate container 3c that surrounds outer side of the second innermost layer, and the fluid containing materials will be introduced from the introduction pipe 4c provided near the base of introduction container 3c.

Thus, in this embodiment, the fluid can be introduced into the introduction container 3e with the distribution of the to be treated materials in the fluid biased to the inner wall direction of the introduction container 3c unchanged, then it can be introduced into the introduction container 3b with the distribution of the materials in the fluid further biased by one layer to the inner wall direction of the introduction container 3b, and furthermore the fluid can be introduced into the cyclone body 21 with the distribution of the materials in the fluid biased by one layer to the inner wall direction of the introduction container 3a.

In addition, in this embodiment, provision of a difference in the diameter cross section of the inlet 4a, inlet 4b, inlet 4c, and the fluid inlet 22 can be employed to control of the introduction speed of the fluid.

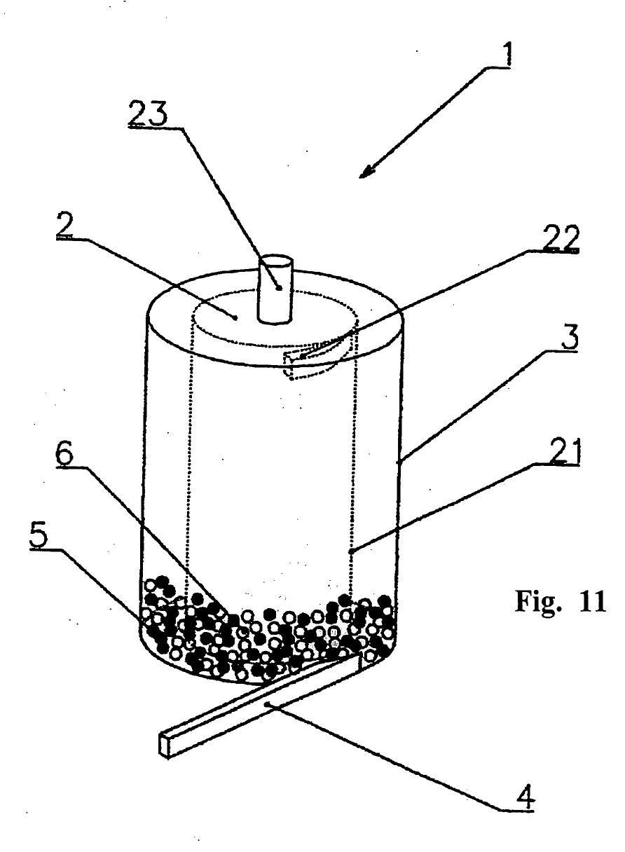

FIG. 11 is a schematic view showing the inventive system 1 according to a sixth embodiment wherein by showing a part of an introduction container in see-through state, inside of the said introduction container 2 is made visible.

This embodiment comprises a cyclone 2, an introduction container 3 and an introduction pipe 4, wherein the almost cylindrical introduction container 3 encloses a cyclone body 21, and furthermore, a catalyst 5 and/or an absorbent 6 are provided in the cyclone body 21 and the introduction container 3.

This embodiment may be especially useful for gasifying a part or all of materials to be treated by subjecting fluid containing the materials to a swirling motion in the introduction container 3, and treating the remaining materials that are collected without being gasified, and gasified materials with a catalyst or absorbent provided in the introduction container 3 and the cyclone body. This can significantly extend intervals needed for removal of collected materials or realize so-called free maintenance.

In addition, as the cyclone 2 to be used in this embodiment does not have to actively collect materials, a cyclone having no lower part of an almost conical body provided following the upper part of an almost cylindrical body 211 for swirling fluid is used, and the base of the cyclone body 21 and that of the introduction container 3 are formed of common material, i.e., a part of the base of the cyclone body 21 and that of the introduction container 3 are used partly in common, thus further improving durability.

The inventive method and the inventive system can suitably treat exhaust gas emitted from various industries such as manufacturing, power generation, construction, waste-disposal, and agriculture, or gas emissions from various transport facilities such as bikes, automobiles, trucks, buses, locomotives and marine vessels, etc. can be listed. In short, the inventive method applies to every type of fluid containing materials to be treated to be generated by some kind of production activities. Therefore, they are not limited to a dust removal device or an incinerator, but can be applied to kitchen appliances, smokeless roasters, dust collection equipment, air purification system equipment for clean rooms, an exhaust gas treatment device for marine vessels, construction machinery, agricultural equipment, steam locomotives, diesel locomotives, food scrap treatment device, dehydrator, sawdust separator or leather waste sorter, etc.

The foregoing relates to a preferred exemplary embodiment of the invention, it being understood that other variants and embodiments thereof are possible within the spirit and scope of the invention, the latter being defined by the appended claims.

1-22. (canceled)

23. A method of introducing fluid containing materials to be treated into a cyclone including a cyclone body for swirling fluid, a fluid inlet for introducing the fluid, and an outlet duct for evacuating the fluid, the method of comprising enclosing at least a part or all of the cyclone body in an introduction container, exposing the fluid inlet in the introduction container, introducing the fluid containing the materials to be treated into the introduction container, and introducing the fluid and materials into the cyclone body from the introduction container without continuous piping.

24. The method according to claim 23, further comprising protruding the open leading end of the fluid inlet in the introduction container.

25. The method of according to claim 23, wherein the introduction container is substantially cylindrical and encloses the cyclone body, wherein the fluid containing the materials to be treated is introduced into the introducing container in a direction substantially tangential to the inner wall of the introduction container, and wherein the fluid is subjected to a swirling motion in introduction container before entering the cyclone body.

26. The method of according to claim 24, wherein the introduction container is substantially cylindrical and encloses the cyclone body, wherein the fluid containing the materials to be treated is introduced into the introducing container in a direction substantially tangential to the inner wall of the introduction container, and wherein the fluid is subjected to a swirling motion in introduction container before entering the cyclone body.

27. A cyclone system for providing fluid containing materials to be treated with swirling motion and treating the to be treated materials in the fluid, the cyclone system comprising,
a cyclone body for swirling the fluid, and materials to be treated
a fluid inlet for introducing the fluid into the cyclone body
an outlet duct for evacuating the fluid,
an introduction container enclosing at least a part or all of said cyclone body, said fluid inlet being exposed in the said introduction container, and
an introduction pipe for introducing fluid containing the to be treated materials into the introduction container.

28. The cyclone system according to claim 27, further comprising a difference between the cross section of the introduction pipe and the inlet, the cross section difference controlling the speed of introducing the fluid into the cyclone body.

29. The cyclone system according to claim 27, further comprising a plurality of cyclones each having at least a part or all of their respective cyclone bodies enclosed within one introduction container, the leading end of the respective fluid inlets into each of said plurality of cyclones being exposed in the introduction container.

30. The cyclone system according to claim 28, further comprising a plurality of cyclones each having at least a part or all of their respective cyclone bodies enclosed within one introduction container, the leading end of the respective fluid inlets into each of said plurality of cyclones being exposed in the introduction container.

31. The cyclone system according to claim 28, wherein the a plurality of cyclones comprises an even number of cyclones, and wherein the direction of the swirling current in half the cyclones are opposite in direction to the swirling current in the remaining half of the cyclones.

32. The cyclone system according to claim 27, wherein the fluid inlet comprises a duct having an open inlet end protruding into the introduction container.

33. The cyclone system according to claim 31, wherein the fluid inlet comprises a duct having an open inlet end protruding into the introduction container.

34. The cyclone system according to claim 27, wherein the cyclone body is enclosed within the introduction container.

35. The cyclone system according to claim 32, wherein the cyclone bodies are enclosed within the introduction container.

36. The cyclone system according to claim 34, wherein the introduction pipe is connected to the introduction container in a manner to introduce the fluid in a direction tangential to the inner wall of the introduction container.

37. The cyclone system according to claim 36, wherein the fluid inlet in the cyclone is opposed to the swirling current in the introduction container.

38. The cyclone system according to claim 36, wherein the open leading end of the fluid inlet is arranged near the inner wall of the introduction container.

39. The cyclone system according to claim 36, wherein the open leading end of the fluid inlet is arranged near the center of the space between the cyclone body and the inner wall of the introduction container.

40. The cyclone system according to claim 36, wherein the position of the open leading end of the fluid inlet may be varied from a position adjacent the inner wall of the introduction container and a position spaced from the inner wall of the introduction container.

41. The cyclone system according to claim 36, wherein the introduction container has a substantially circular cross section, and wherein the diameter of a top wall in the introduction container is smaller than that of its base.

42. The cyclone system according to claim 41, wherein the inside diameter of the introduction container decreases in phases from its base to its top.

43. The cyclone system according to claim 27, comprising a plurality of separate introduction containers, said plurality of introduction containers sequentially enclosing at least a part or all of the cyclone body.

44. The cyclone system according to claim 42, comprising a plurality of separate introduction containers, said plurality of introduction containers sequentially enclosing at least a part or all of the cyclone bodies.

45. The cyclone system according to claim 27, further comprising a catalyst and/or an absorbent in the introduction container and/or in the cyclone body.

46. The cyclone system according to claim 43, further comprising a catalyst and/or an absorbent in the introduction container and/or in the cyclone body.

47. A dust removal device comprising the cyclone system according to claim 27.

48. A dust removal device comprising the cyclone system according to claim 45.

49. An incinerator comprising the cyclone system according to claim 27.

50. An incinerator comprising the cyclone system according to claim 45.

51. An exhaust gas treatment method for treating exhaust gas discharged from internal combustion engines the method comprising passing the exhaust gas through the cyclone system according to claim 27.

52. An exhaust gas treatment method for treating exhaust gas discharged from internal combustion engines the method comprising passing the exhaust gas through the cyclone system according to claim 45.
